(19) United States
(12) Patent Application Publication
(10) Pub. No.: US 2026/0245776 A1
(43) Pub. Date: Aug. 20, 2026

(54) PLANAR MAGNETIC KINETIC DEVICE WITH VERTEX-MOUNTED ROTATIONAL ELEMENTS

(71) Applicants: Fredrick D. Tumlinson, Castro Valley, CA (US); Alexandre R. Tumlinson, Castro Valley, CA (US)

(72) Inventors: Fredrick D. Tumlinson, Castro Valley, CA (US); Alexandre R. Tumlinson, Castro Valley, CA (US)

(21) Appl. No.: 19/540,576

(22) Filed: Feb. 13, 2026

Related U.S. Application Data
(60) Provisional application No. 63/758,897, filed on Feb. 14, 2025.

(51) Int. Cl. H01F 7/02; A63H 33/08

(52) U.S. Cl. CPC H01F 7/0263; A63H 33/08

(57) ABSTRACT

A kinetic magnetic toy system designed for tactile manipulation. The system comprises a planar frame with rotatable magnetic objects mounted at the vertices. The vertex regions feature cutouts to allow manual spinning of the magnets. The magnets rotate on axes coplanar with the frame, creating a “flipping” interaction. Embodiments include conical pivots with differential radii for durability, multi-material housings for acoustic dampening, and central spherical pivots that allow for slip-fit rotation. The system may be configured as a set of interacting frames with pencil-mounting apertures or hexagonal geometries. Sublimation printing may be integrated into the frame or magnet housings.

### CROSS-REFERENCE TO RELATED APPLICATIONS

This application claims the benefit of U.S. Provisional Application No. 63/758,897, filed on Feb. 14, 2025, the contents of which are incorporated herein by reference.

### FIELD OF THE INVENTION

The present disclosure relates generally to magnetic kinetic toys and, more particularly, to a substantially planar handheld device comprising vertex-mounted rotating magnetic objects configured for tactile engagement, acoustic modulation, and multi-functional mounting.

### BACKGROUND OF THE INVENTION

Handheld kinetic devices, often referred to as “fidget toys,” provide sensory regulation and cognitive focus through tactile and haptic feedback.

### Description of Related Art

One category of related devices includes “magnetic slider plates.” These typically consist of two planar bodies with magnets embedded at the corners configured to slide linearly relative to one another. The motion of slider plates is generally constrained to a single plane (X-Y translation), which may limit the variety of haptic feedback.

Another category includes magnetic construction tiles. These devices often utilize cylindrical magnets captured within the midpoints of the frame's linear edges to facilitate structural alignment. In such configurations, the magnets are typically shielded from direct manual contact and the rotational leverage available for kinetic manipulation is restricted. These devices are generally configured for structural stability rather than dynamic kinetic oscillation.

### SUMMARY OF THE INVENTION

The present disclosure provides a kinetic toy comprising a structural frame with a plurality of magnetic objects rotatably mounted at the frame's vertex regions.

In one embodiment, the vertex regions define an open geometry or “cutout” that exposes a portion of the magnetic object, configured to allow for direct tactile manipulation. The device utilizes a conical pivot system featuring differential radii—specifically, a smaller radius at an axle tip and a larger radius at a receptacle fillet—creating a self-centering point-contact interface that is resistant to lateral impact.

The device may be provided in various configurations, including a two-frame set where one unit features a rotatable pivot sphere and the other a receiving divot. The pivot sphere may be mounted via a slip-fit interface, allowing the frame to rotate relative to the sphere. Additional features may include sublimation-printed surfaces on the frame or magnetic housings, tactile poppets for auxiliary sensory feedback, and acoustic dampening layers.

### BRIEF DESCRIPTION OF THE DRAWINGS

FIG. 1 is a perspective view of the kinetic device in accordance with one embodiment.

FIG. 2 is a cross-sectional detailed view of the conical pivot joint with differential radii.

FIG. 3 is a cross-sectional view of the magnetic housing featuring the multi-material acoustic dampening layer.

FIG. 4 is a perspective view illustrating the interference fit between the circular mounting aperture and a hexagonal shaft.

FIG. 5 is an exploded view of an embodiment utilizing a central spherical pivot (slip-fit).

FIG. 6 illustrates a hexagonal frame embodiment with six magnetic objects.

FIG. 7 illustrates a set consisting of two complimentary devices intended to interact with each other

FIG. 8 illustrates a set consisting of three complimentary devices intended to interact with each other

FIG. 9 illustrates a display attachment removably coupled to the frame

FIG. 10 illustrates internal relieve cavities and plugs

FIG. 11 illustrates an alternative wire-form embodiment

### DETAILED DESCRIPTION OF THE INVENTION

The following description provides exemplary embodiments of the invention. These examples are provided for illustrative purposes and are not intended to limit the scope of the protection.

### Structural Overview and Vertex Geometry

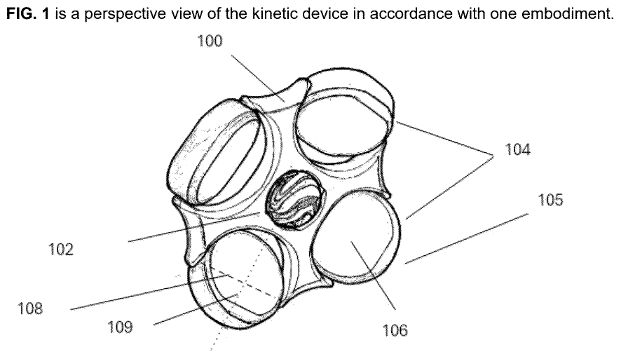

Referring to FIG. 1, the device comprises a substantially planar frame [100] defining a central region [102] and a plurality of distal vertex regions [1049]. Each vertex region includes a structural cutout [105] or relief in the frame structure. The cutout [105] is configured to expose a portion of the magnetic object [106] such that a user may directly contact and rotate the magnetic object with a finger.

Each magnetic object [106] is configured to rotate about a fixed axis [108] that is substantially coplanar with the primary plane of the frame. In the illustrated embodiments, the axes are oriented substantially perpendicular to a radial line [109] extending from the central region [102].

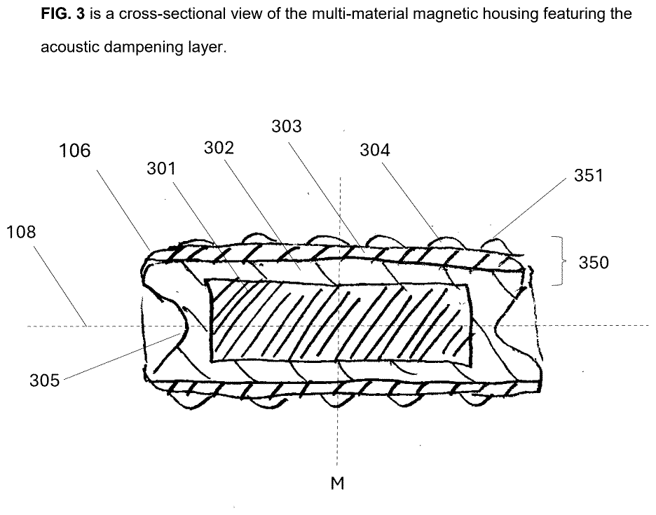

As illustrated in the cross-sectional view of FIG. 3, the magnetic object [106] comprises a permanent magnet having a magnetic axis [M] defined by a North pole and a South pole. This magnetic axis [M] is oriented substantially perpendicular to the fixed axis of rotation [108]. As the magnetic object rotates, the magnetic axis [M] rotates within a plane that is substantially perpendicular to the primary plane of the frame [100]. In a preferred embodiment, this plane of magnetic rotation is coincident with a radial line extending from the center of the frame through the center of the vertex region, such that the magnetic poles are cyclically presented at the distal-most face of the vertex region.

In an exemplary embodiment, the frame [100] defines a substantially square geometry measuring approximately 50 mm×50 mm, with vertex-mounted magnetic objects [106] each having a diameter of approximately 20 mm. The frame and the vertex-mounted objects have substantially equal thickness of about 8 mm.

### Rotational Interface Systems

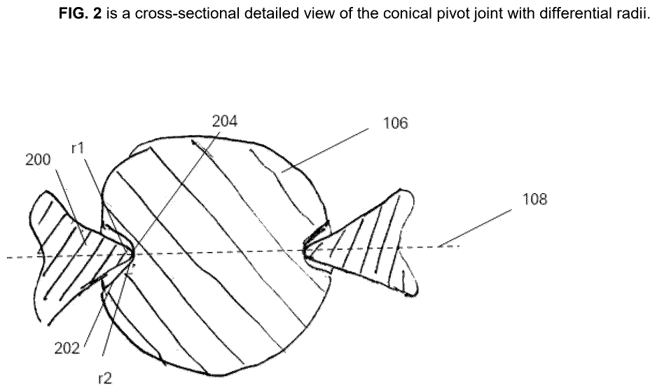

The rotation of the magnetic objects [106] may be facilitated by a conical pivot architecture as shown in cross section in FIG. 2. The frame comprises a conical axle [200] extending into a receptacle [202], wherein the receptacle may also define a conical face complementary to the axle. To ensure low-friction rotation, the interface utilizes differential radii geometry. The conical axle [200] terminates in a tip having a first radius (r1), while the interior apex of the receptacle [202] terminates in a fillet having a second radius (r2), where r2>r1. This prevents the conical surfaces from mating flush, resulting in a self-centering, point-contact interface [204].

In alternative embodiments, the rotational interface may comprise standard ball bearings, sleeve bearings, or bushings (not shown) configured to provide low-friction rotation of the magnetic objects.

### Magnetic Multipole Alignment and Virtual Gearing

Due to the low-friction rotational interface and the proximity of the vertex-mounted magnetic objects [106], the system exhibits emergent magnetic ordering. The free-spinning magnetic objects naturally rotate to orient their poles in an alternating arrangement (e.g., North-South-North-South). This self-alignment creates a virtual magnetic multipole field (e.g., a quadrupole in a four-magnet square frame or a hexapole in a six-magnet hexagonal frame).

Crucially, this multipole arrangement does not merely act as a static lock. Instead, it facilitates a mode of synchronized rotation or “virtual gearing.” As a user manually rotates a first magnetic object, the varying magnetic flux induces a corresponding rotation in adjacent magnetic objects to maintain the energetically favorable multipole alignment. This interaction mimics a mechanical linkage or “hidden cable” connecting the axles, allowing the plurality of magnets to rotate in together in a coordinated manner, maintaining their alternating pole arrangement. The result is a coherent, low-friction rotation where the movement of one element instantaneously drives its neighbors without direct physical contact.

### Multi-Frame Interaction and Degrees of Freedom

When a plurality of frames [100] are brought into proximity, their respective vertex-mounted magnetic objects [106] automatically align their poles to ensure mutual attraction.

When a single magnetic object of a first frame is in contact with a single magnetic object of a second frame, the two frames are coupled at a single point. This coupling permits multiple degrees of freedom: the frames may pivot around the shared North-South (N-S) axis of the magnet pair, and simultaneously rotate around the individual pivot axes [108] of each respective magnetic object. This multi-axial freedom allows the frames to “flip” or transition around one another with a high degree of kinematic flexibility.

Furthermore, when two or more pairs of vertex-mounted magnetic objects are coupled between a plurality of frames, the additional points of contact further constrain the degrees of freedom. This allows for the construction of complex, stable, and rigid multi-frame structures, effectively turning the individual kinetic units into a modular building system.

### Configurations and Sets

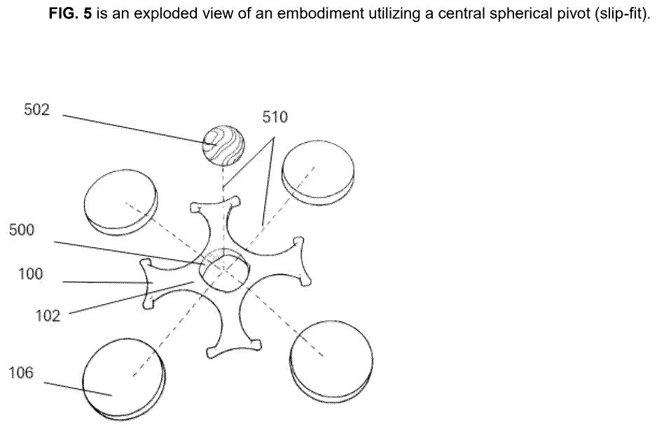

The device may be provided in various modular configurations. Referring to FIG. 5, the central region [102] may include a socket [500] holding a spherical member [502] (e.g., a metal, glass, ceramic, or polymer sphere). In one embodiment, the socket provides a slip-fit, allowing the frame to rotate relative to the spherical member [502] while the member is gripped by a user. Dashed lines illustrate assembly directions [510] in the exploded view as the magnetic objects [106] and spherical member [502] are mated to the frame [100]. In one embodiment, to accommodate manufacturing tolerances in commercially available glass spheres (which may vary by ±0.5 mm or more), the frame may be produced with a plurality of socket sizes (e.g., 14.0 mm, 14.3 mm, 14.6, 15.0 mm diameter), allowing selection of an appropriately sized socket for a given batch of spheres to maintain the desired slip-fit interface.

Kinetic Balancing and Dynamic Retention The performance of the device during high-velocity maneuvers relies on a calibrated relationship between the mass of the frame [100] and magnetic objects [106] and the magnetic attractive force of the objects [106]. Referring to FIG. 3, the magnetic object comprises a magnet [301] encapsulated within a housing. The thickness of non-magnetic material [350] situated between the magnet [301] and the exterior impact surface [351] is tuned define a predetermined breakaway force. This calibration ensures that the magnetic attraction at a contact vertex provides sufficient dynamic retention to prevent unintended detachment during rotation, while the attraction between contacting vertices remains low enough to allow a user to easily initiate movement.

In embodiments intended for use by young children, the magnetic objects [106] may be permanently secured to the frame [100] to prevent removal and eliminate choking hazards associated with small magnetic parts. Permanent attachment may be achieved through ultrasonic welding, adhesive bonding, snap-fit retention features with interference geometry, overmolding, or mechanical staking of the axle [200]. In such embodiments, the rotational interface remains functional while the magnetic object cannot be separated from the frame without destruction of the assembly. Likewise, the press-in slip-fit implementation of the spherical pivot may be replaced by a more secure encapsulation of the sphere or a replacement with a fixed protrusion.

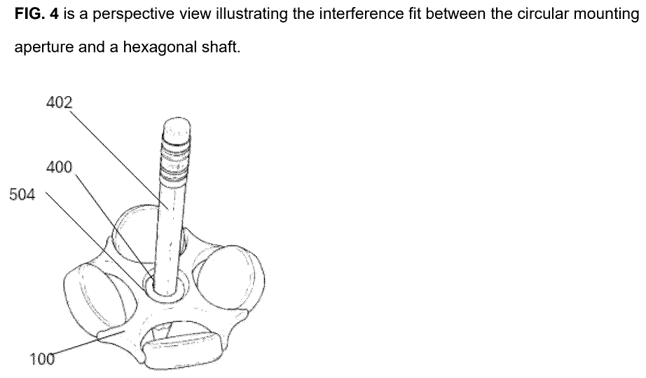

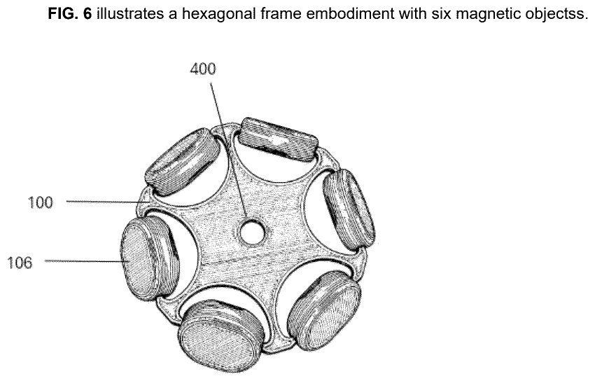

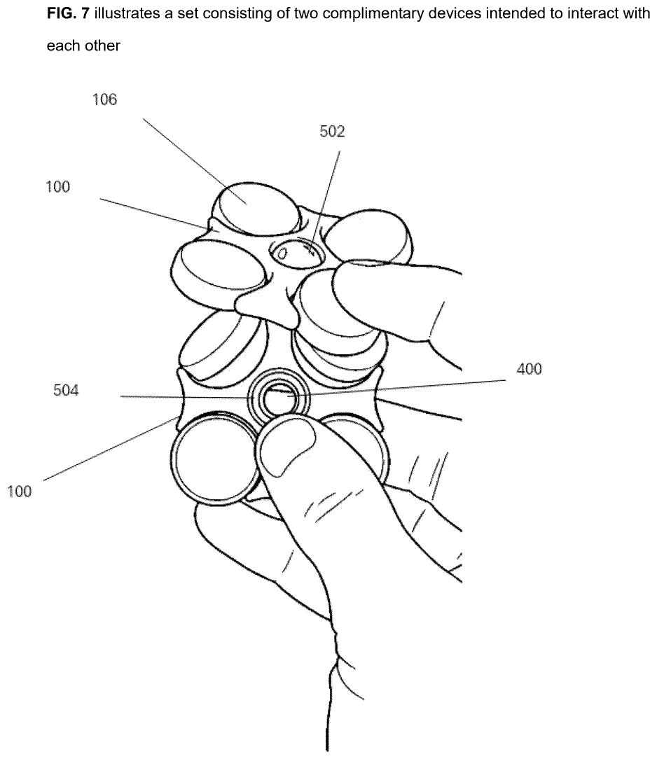

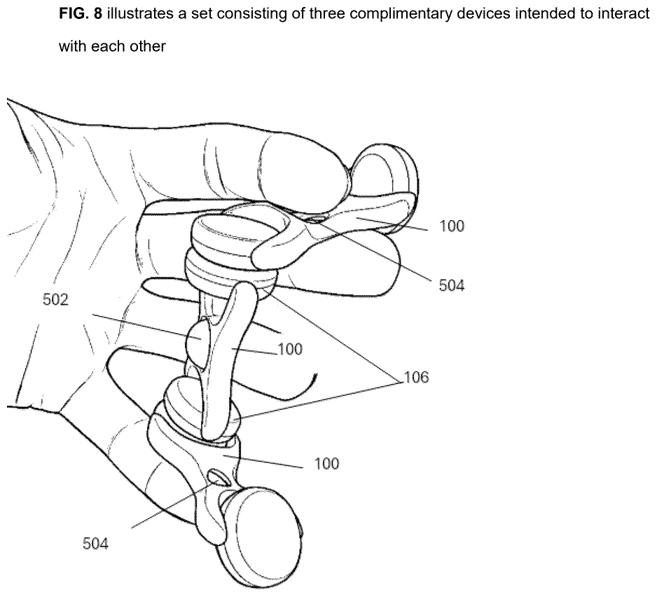

The system may be provided as a set (FIG. 7) comprising a first frame unit featuring a central spherical pivot [502] and a second frame unit featuring a central divot [504]. The divot is configured to accommodate the protrusion of the spherical pivot, allowing the first and second frame units to rest in a flush, stacked configuration. In an embodiment, both frame units define a substantially square geometry comprising exactly four magnetic objects disposed at the four corners. The second frame unit may further define a mounting aperture [400] (see FIG. 4) configured with a diameter (e.g., 7.1 mm) to create an interference fit with a hexagonal shaft [402]. Other embodiments include a hexagonal frame with six magnetic objects (FIG. 6) or a set of three elongate frames featuring two magnetic objects each (FIG. 8).

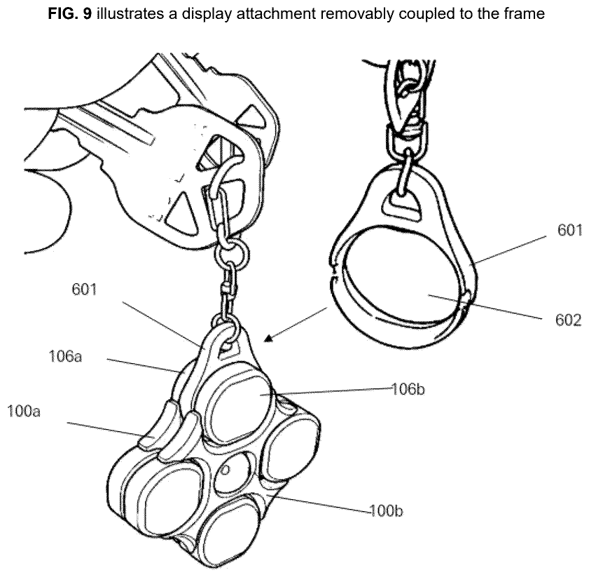

In a further embodiment, the system comprises a display attachment (as shown in FIG. 9) configured to removably couple to the frame. The display attachment [601] is shaped to seat within the negative space or ‘void’ defined between two adjacent frames, stacked together. It utilizes the magnetic clamping force of the rotatable magnets [106] to secure itself between two frames [100], allowing the device to be suspended from a keychain, backpack, or lanyard without requiring permanent fasteners. An opening [602] in the display attachment allows two neighboring rotatable magnets [106a, 106b] on opposing frames [100a, 100b] to fully contact each other and generate maximum force to retain the attachment. The attachment may be released by manually overcoming the magnetic clamping force.

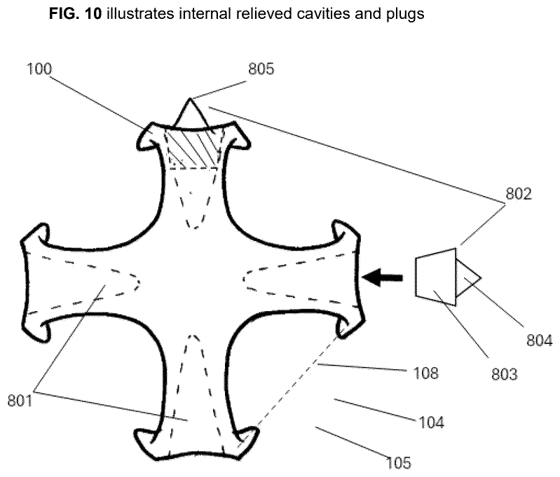

Additional Sensory Features To further enhance tactile engagement, the frame or surface may be enhanced with additional features. The frame may include a bistable tactile poppet (e.g., a silicone hemispheric bubble that ‘simulates popping bubble wrap’) integrated into the central region. The frame may be manufactured via injection molding utilizing internal relief cavities (FIG. 10) to maintain uniform wall thickness and prevent ‘sink’ artifacts due to thermal shrinkage. These cavities [801] hollowed out from the frame may be configured to receive modular plugs [802]. In one embodiment, these plugs may feature an internal geometry [803] for securing the plug into the cavity, and an external geometry [804] for modifying the external surface shape of the frame. In an embodiment, a tapered or conical geometry protrudes to a spike [805] extending from an arm of the frame. These tapered plugs serve a dual function: filling the relief cavity and providing tactile sensory feedback (e.g., functioning as acupressure points) to the user's hand during manipulation. These cavities also form flexible attachment points for various other items, that may be cosmetic or functional.

To enable use of the device in sound sensitive environments, or with sound sensitive individuals, each magnetic object may further comprise a multi-material housing as illustrated in cross-section in (FIG. 3). A magnetic core [301] is surrounded by a rigid core material [302] and a superficial elastomeric impact layer [303]. Regarding the impact layer, in a preferred embodiment, the elastomeric bumper has a thickness between 0.1 mm and 0.4 mm. This layer may comprise a surface texture (such as knurling or ribs) [304] configured to reduce the effective contact area during impact, thereby modulating the acoustic signature of the device. This multimaterial structure allows the use of a rigid, lubricious material with hardness greater than 50 Shore D such as PETG, ABS, or Polypropylene, in the area of the pivot contact [305], while allowing a soft, sound dampening material with a hardness less than 95 Shore A such as TPU at impact surfaces.

### Alternative Wire-Form Embodiment

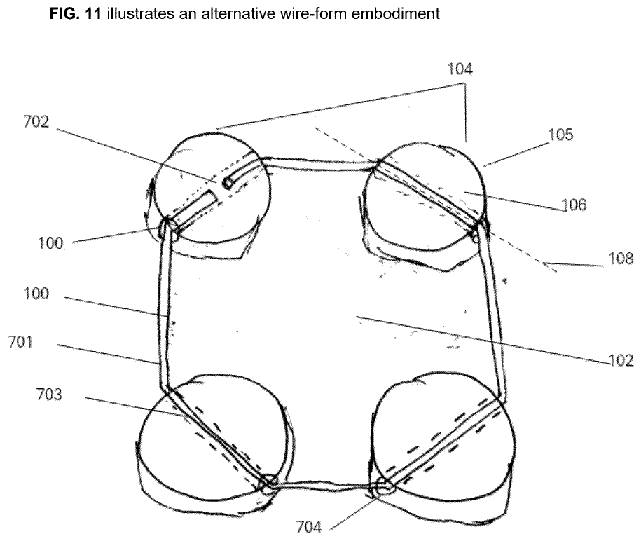

In an alternative embodiment (FIG. 11), the structural frame is formed from a continuous length of rigid wire [701]. The wire is configured to define the frame geometry and the vertex regions. The ends [702] or intermediate sections [703] of the wire may serve as the fixed axles for the magnetic objects. In this configuration, the magnetic objects may feature through-holes [704] or bushings configured to slide onto the wire segments, facilitating a minimalist rotational interface.

### Monolithic Magnetic Object

In an alternative embodiment, the magnetic object [106] may comprise a monolithic body wherein the magnet material and structural housing are formed as a single integral unit. Such monolithic magnetic objects may be fabricated via injection molding of polymer-bonded magnetic composites, sintering of magnetic ceramic materials, or additive manufacturing techniques. The pivot features [200, 305] may be formed directly into the monolithic body during fabrication.

### Surface Treatment and Sublimation

Components such as the frame [100] and housings of the magnetic objects [106] may be formed of a polyester-based polymer, such as PETG. At least one surface of these components may comprise a sublimation-dyed graphic integrated directly into the polymer substrate. This allows for durable, high-resolution decoration that is resistant to wear during kinetic use.

### Broadening Statement

While the embodiments described herein focus on handheld kinetic toys, the principles of vertex-mounted tangential magnetic rotation and the specific conical pivot geometries may be applied to other fields, such as educational models, mechanical haptic interfaces, or modular magnetic coupling systems. Accordingly, the scope of the invention should be determined by the appended claims and their legal equivalents.

What is claimed is:

1. A kinetic magnetic toy comprising: a substantially planar frame defining a central region and a plurality of vertex regions; a plurality of magnetic objects, each rotatably coupled to the frame at one of said vertex regions; wherein each vertex region defines a structural cutout configured to expose a portion of the magnetic object for direct manual tactile manipulation; and wherein each magnetic object is configured to rotate about a fixed axis substantially coplanar with the frame, enabling periodic magnetic coupling between the plurality of magnetic objects.

2. The toy of claim 1, wherein the rotatable coupling comprises a conical axle seated within a receptacle, wherein the axle has a first tip radius r1 and the receptacle has a second radius r2, wherein r1<r2, thereby defining a point-contact interface.

3. The toy of claim 1, further comprising a spherical member disposed within a socket in the central region, wherein the socket is configured to provide a slip-fit allowing the frame to rotate relative to the spherical member while the spherical member is held stationary.

4. A kinetic toy system comprising: a first frame unit comprising a central spherical pivot protruding from a bottom surface; and a second frame unit comprising a central divot configured to accommodate the protrusion of the spherical pivot of the first frame unit when the units are in a stacked configuration; wherein both first and second frame units define a substantially square geometry and comprise exactly four rotatable magnetic objects disposed at four vertices.

5. The system of claim 4, wherein the central divot of the second frame unit defines a through-hole having a diameter configured to create an interference fit with a hexagonal pencil shaft.

6. The toy of claim 1, wherein the magnetic objects further comprise a housing formed of a polyester-based polymer, and wherein an exterior surface of said housing comprises a sublimation-dyed graphic integrated into the polymer.

7. The toy of claim 1, wherein the frame comprises a substantially hexagonal geometry, and wherein the plurality of magnetic objects consists of six magnetic objects disposed at the six vertices of the hexagon.

8. The toy of claim 1, further comprising a bistable tactile poppet integrated into the frame.

9. The toy of claim 1, wherein each magnetic object further comprises a multi-material housing having a rigid core portion and an elastomeric impact bumper portion, wherein the bumper portion has a thickness between about 0.1 mm and 0.4 mm.

10. The toy of claim 9, wherein the elastomeric impact bumper comprises a surface texture configured to modulate acoustic impact noise.

11. The toy of claim 1, wherein the frame is an elongate body having exactly two rotatable magnetic objects disposed at opposing ends, and wherein the toy is provided as a set of three such frames.

12. The toy of claim 1, further comprising a display attachment configured to seat within a void defined between adjacent magnetic objects and secured by magnetic clamping force.

13. The toy of claim 1, wherein the frame defines internal relief cavities configured to receive modular plugs.

14. The toy of claim 13, wherein the modular plugs comprise a tapered geometry configured to provide tactile sensory feedback.

15. The toy of claim 1, wherein the fixed axes of the magnetic objects are oriented substantially tangential to a circumference centered at the central region.

16. The toy of claim 1, wherein at least one magnetic object comprises a monolithic body integrating magnetic material and pivot features.

17. A child-safe kinetic magnetic toy comprising: a structural frame defining a plurality of vertex regions; a plurality of magnetic objects, each permanently secured to the frame at one of said vertex regions in a manner preventing removal without destruction of the assembly; wherein each vertex region defines a structural cutout configured to expose a portion of the magnetic object for direct manual tactile manipulation; and wherein each magnetic object is rotatably coupled to the frame about a fixed axis.

18. The toy of claim 1, wherein the plurality of magnetic objects consists of an even number of magnetic objects, and wherein the magnetic objects are configured to self-align in an alternating pole arrangement forming a multipole magnetic field.

19. The toy of claim 1, wherein the frame defines a primary plane, and the magnetic objects are configured to rotate such that their magnetic poles rotate through a plane substantially perpendicular to said primary plane.

20. The toy of claim 1, wherein the magnetic objects are positioned such that manual rotation of a first magnetic object induces coordinated rotation of at least one adjacent magnetic object through magnetic interaction.

21. The toy of claim 17, wherein the frame defines at least three vertex regions and wherein the magnetic objects are positioned such that manual rotation of a first magnetic object induces coordinated rotation of at least two adjacent magnetic objects through magnetic interaction.
